(19) United States
(12) Patent Application Publication
(10) Pub. No.: US 2009/0283468 A1
(43) Pub. Date: Nov. 19, 2009

(54) PLEATED FILTER CARTRIDGE

(76) Inventor: Yoshiki Nomura, Chiba-ken (JP)

Correspondence Address: Entegris, Inc., 129 CONCORD ROAD, BILLERICA, MA, 01821-4600, US

(21) Appl. No.: 12/296,302

(22) PCT Filed: Mar. 14, 2007
(86) PCT No.: PCT/JP2007/055044

§ 371 Date: Oct. 28, 2008

(30) Foreign Application Priority Data
Apr. 25, 2006 (JP) 2006-120958

(51) Int. Cl. B01D 29/56

(52) U.S. Cl. 210/300

(57) ABSTRACT

[Problems] provide a pleated filter cartridge that realizes an increase of surface area per volume of filter material (porous filter membrane) to thereby enable a flow rate greater than in the prior art with respect to the same volume.

[Means for Solving Problems] There is provided a filter cartridge accommodating a filter material composed of a pleated porous membrane, a pleated nonwoven net disposed on the upstream side of the membrane and a pleated woven net disposed on the downstream side of the membrane, these joined together at edge portions thereof. This filter cartridge realizes a flow rate greater than that of reference filter cartridge accommodating a filter material composed of a pleated porous membrane, a pleated woven net disposed on the upstream side of the membrane and a pleated woven net disposed on the downstream side of the membrane, these joined together at edge portions thereof

### TECHNICAL FIELD

The present invention relates to a pleated filter cartridge and more particularly to a pleated filter cartridge having an increased surface area per unit volume of the filter material.

### BACKGROUND

In membrane filter cartridges, pleating has been used to increase the surface area per unit volume of filter material, and thus increases the particle holding capacity of the cartridge. These pleated filter cartridges can utilize non-woven fabrics as drainage layers and separator layers in the cartridges.

U.S. Pat. No. 5,279,731 discloses that, in order to achieve optimum performance of a pleated filter, it is necessary to provide a relatively coarse upstream drainage layer so as to give a fluid passage for draining between the pleats and a void space for the accumulation of solid contents. The patent also discloses that it is necessary to provide a relatively coarse downstream drainage layer to drain filtrate between the pleats from an inner filtration layer and also to support the filter medium against applied pressure. The patent further discloses that the drainage layers are conventionally formed separately from the filter membrane and made of non-woven fabrics or net materials disposed on both sides of the filter membrane (see GB-A 1460925).

U.S. Pat. No. 5,543,047 discloses a filter with two drainage layers, in which upstream and downstream drainage layers can be of the same or different construction. The patent also discloses that, when both drainage layers have a substantially same flow resistance in plane direction (the direction from one edge to other edge), the pressure drop across the filter membrane may be lowest and a filter life may be longest. The patent further discloses that regardless of whether or not the drainage layers are made of the same material, the drainage layers are preferably selected so as to have the same flow resistance in the plane direction. For ease of manufacture, it is convenient to use identical materials for both drainage layers, thereby assuring the same edgewise flow resistance through both drainage layers.

This patent also discloses that the upstream and downstream drainage layers may have different characteristics and these characteristics may be varied to provide a desired effect. For example, where the thickness of the filter member (a composite body of the filter membrane and the drain layer) is fixed, e.g. in order to fix the filtration area of the filter membrane within an envelope the thickness of the upstream drain layer may be thinner than that of the downstream drain layer.

Patent document 1: U.S. Pat. No. 5,279,731

Patent document 2: GB-A 1460925

Patent document 3: U.S. Pat. No. 5,543,047

### DISCLOSURE OF THE INVENTION

### Problem to be Solved by the Invention

The present invention is directed to a pleated filter cartridge having an increased surface area per unit volume of the filter material (the porous filter membrane) as well as an increased the flow rate than the conventional filter cartridge having the same volume.

### Means to Solve the Problem

According to one embodiment of the present invention, the present invention provides a filter cartridge having a filter material, which comprises a pleated porous filter membrane, a pleated non-woven net or an apertured film net disposed on the upstream side of said membrane, and a pleated woven net or drainage layer disposed on the downstream side of said membrane, these are joined together along their edges. In some embodiments of the present inventions the thickness of the upstream non-woven net or apertured film net is chosen to provide increased flow rate of a liquid trough the cartridge. In other embodiments of the present invention the upstream non-woven net or apertured film net thicker than the downstream woven net can be used.

In various embodiments of the present invention, a filter cartridge has a volume and includes a pleated porous filter membrane and a pleated woven net or drainage layer disposed on the upstream side of said filter membrane (both of the filter membrane and net are pleated together and joined along their edges), and the filter cartridge allows a larger flow rate of a fluid through the filter cartridge than that of a fluid through a reference (control) filter cartridge having the same volume as this filter cartridge and comprising a pleated porous membrane with the same number of the pleats as the filter cartridge, a pleated non-woven net disposed on the upstream side of the membranes and a pleated woven net disposed on the downstream side of the membrane.

According to one embodiment of the present invention, the filter cartridge with the non-woven net disposed on the upstream side has a first membrane area and the reference filter cartridge has a second membrane area, and a ratio of the first membrane area to the second membrane area can be chosen less than a ratio of a flow rate through the first membrane to a flow rate through the second membrane.

According to other embodiments of the present invention, the non-woven drainage layer can be pleated with the membrane using the same pleater as the woven drainage layer.

According to one embodiment of the present invention, the filter cartridge has a volume such that a further increase in membrane area relative to the fixed volume of the cartridge with a woven net disposed on the upstream side of the membrane and a woven net disposed on the downstream side of the membrane would result in a decrease in the fluid flow rate through the filter under a set of fixed feed conditions of flow and pressure.

According to one embodiment of the present invention, the filter cartridge has a volume such that a further increase in pleat density of the membrane with the woven net disposed on the retentate side of the membrane and the woven net disposed on the permeate side of the membrane would result in a decrease in the fluid flow rate through the filter under the set of fixed feed conditions of flow and pressure. By having the non-woven net disposed on the upstream side of the membrane and the woven net disposed on the downstream side of the membrane, a greater area of membrane can be packed into the cartridge in high density, resulting in a greater fluid flow rate than the reference filter cartridge, which has the woven net disposed on the upstream side of the membrane and the woven net disposed on the downstream side of the membrane and has the same cartridge volume.

According to other embodiments of the filter cartridge, it can be characterized in that, when the non-woven net disposed on the upstream side of the membrane is not used and the woven net disposed on the downstream side of the membrane is used, a further increase in membrane area relative to the fixed volume of the cartridge would result in a decrease in the fluid flow rate through the filter under the set of fixed feed conditions of flow and pressure.

According to one embodiment of the present invention, when the non-woven net disposed on the retentate side of the membrane is not used and the woven net disposed on the permeate side of the membrane is used, a further increase in the pleat density (number of pleats per unit arc length) of the membrane would decrease the fluid flow rate through the filter under the set of fixed feed conditions of flow and pressure.

Especially when a further increase in membrane area would reduce the flow of the pleated filter cartridge, these embodiments of the present invention improve the flow through the filter cartridge, by using the pleated filter cartridge with the woven net disposed on one side of the porous membrane and the non-woven net disposed on the other side of the porous membrane. In one embodiment, the membrane is a microporous flat sheet. The non-woven net material can be disposed on the inner surface and outer surface of the porous membrane and pleated with the membrane. In one embodiment of the pleated filter cartridge, the non-woven material can be disposed on the retentate side of the membrane) while the woven or non-shrinking material net is disposed on the permeate side of the membrane, and this combination body (laminated body) can be pleated together. In one embodiment of the pleated filter cartridge, the nonwoven material can be disposed on the outside of the membrane, while the woven or non-shrinking material net can be disposed on the inside of the membrane, and this combination body (laminated body) can be pleated together.

The combination of the woven net disposed on the upstream side of the microporous membrane facing cage and the woven net disposed on the downstream side of the membrane facing core can increase the membrane area that can be utilized in the fixed volume of the cartridge filter (a space between the cage and the core). In one embodiment of the invention, the available flow rate and filtration area could be increase by greater than or equal about 18% in some embodiments, greater than or equal about 20% in other embodiments, greater than or equal about 30% in yet other embodiments, greater than about 40% or equal in further other embodiments relative to a filter cartridge, which has a similar pleating structure, a membrane area and a volume, but comprises woven drainage layers disposed on both sides of the porous membranes.

In one embodiment of the invention, a non-woven net or an apertured net material can be used. This non-woven net or apertured net is thicker than the woven net. The non-woven net can be used but not limited to materials like Dexmet 2TF9-100H (thickness of 270 μm), Dexmet 5TF8-105 (thickness of 390 μm) (trade name, Dexmet products in America), or others. In some cases, the nonwoven net is a thermoplastic, in other cases, it is a bondable perfluorinated material, in yet other cases, it is a thermoplastic material, which can be pleated and bonded with the porous membrane at edges. The woven material in one embodiment of the present invention can be but is not limited to thermoplastic materials, in other cases, the woven material is a perfluorinated material such as Gunze (trade name of the woven net, Gunze products).

An increased filtration area and/or flow rate can be obtained without increasing in fluid pressure or the size of the filter cartridge. This can increase processing capacity (throughput) without the use of a large pump and provide for greater particle holding capacity without increasing filter cartridge installation area (footprint).

FIG. 1 is a graph illustrating the flow rate for various configurations of the woven net materials and the nonwoven net materials. The tests were performed on ATX and ATM filter cartridges available from Entegris, Inc (USA) that were modified to include a larger number of pleats and different types and arrangements of nets.

FIG. 2 illustrates that the filter membrane area that can be utilized in the volume of the filter cartridge (the space between the cage and the core) can be increased by pleating of a combination body (laminated body) of the woven net disposed on the outside (upstream side) of the microporous membrane facing the cage, and the woven net disposed on the inside (downstream side) of the membrane facing the core. FIG. 2 illustrates that a Type A filter cartridge has a smaller membrane area, and it has fewer pleats (per arc length unit) than Type B filter cartridge having the same cartridge volume as that of the Type A filter cartridge. FIG. 2 also illustrates that, for the woven net disposed on the upstream and downstream sides of pleated membrane surfaces, a further increase in the membrane area of the Type A filter cartridge having the fixed volume so as to give the Type B filter cartridge having the same volume as that of Type A filter cartridge could result in a decrease of the fluid flow under fixed feed conditions. On the contrary, according to the present invention, when the pleated nonwoven net is bonded to the upstream side of the membrane of the Type A filter cartridge and the pleated woven net is bonded to the downstream side thereof, an increased fluid flow can be led under fixed feed conditions, by increasing the membrane area of the Type A filter cartridge having fixed volume so as to give the same membrane area as that of the Type B filter cartridge having same fixed volume.

FIG. 3 illustrates that the filter cartridge used in embodiments of the present invention has a core, a pleated inner net, a pleated membrane, and a pleated outer net within a support cage.

FIG. 4 is a cross-sectional illustration of the pleated microporous membrane bonded to inner and upstream net contained in the volume between the core and the cage of the filter cartridge (top and bottom end caps not shown).

### BEST MODES OF THE INVENTION

Before the structures and methods of the present inventions are described in detail, it is to be understood that the present invention is not limited to the particular molecules, compositions, methodologies or protocols described, as these may vary. It is also to be understood that terminology used in the description is for the purpose of describing the particular embodiments only, and is not intended to limit the scope of the present invention, which will be limited only by the appended claims.

Unless defined otherwise, technical terms used herein should be interpreted to have the same meanings as commonly understood by one of ordinary skill in the art. Although any methods and materials similar or equivalent to those described herein can be used in the practice or testing of embodiments of the present invention, the preferred methods, devices, and materials are now described. All publications mentioned herein are incorporated by reference. Nothing herein is to be construed as an admission that the invention is not entitled to antedate such disclosure by virtue of prior invention.

In one embodiment of the present invention, the fluid flow in the pleated filter cartridge, comprising in particular M type pleats (more pleats are set on the cage side than the core side as described in JP 62-87710A), W type pleats (fewer pleats are set on the cage side than the core side), or a combination of these types pleats, is improved by replacing the woven net with the non-woven net material. The non-woven net material can be disposed on the inside and outside planes of the porous membrane and pleated with the porous membrane. In some embodiments, the non-woven net material is disposed on one side of the porous membranes while the woven or non-shrinking net material is disposed on the other side of the porous membrane, and this combination body is pleated. In other embodiments of the pleated filter cartridge, the non-woven net material is disposed on the side of the membrane facing the outer surfaces (outer diameter surfaces) of the filter cartridge, while the woven net material or non-shrinking material is disposed on the side of the membrane facing the inner surfaces (inner diameter surfaces) of the filter cartridge, and this combination of net materials and membranes can be pleated and bonded together.

Filter elements in embodiments of the present invention include pleated microporous membranes that are used to filter fluids. Filtration can include the removal of particulates, e.g., by sieving by the microporous membrane or trapping within the membrane, the isolation of impurities, e.g., by ion exchange resins or adsorbents or chelators, and others. In some embodiments of the present invention, a pleated filter element comprising a plurality of pleats is arranged around a tubular core to define a cylinder. For example, as shown in a schematic cross-sectional view of FIG. 4, the individual pleats extend outward from the core toward the outer surface of the filter element.

Density of pleats refers to the number of pleats (the number of crest to crest of the pleats or the number of trough to trough of the pleats) per arc length unit or per linear length unit of the cartridge. An arc is any smooth curve joining two points and the length of the arc is its length. In some pleating configurations, the membrane area or density of pleats of membrane, which has the upstream and downstream woven nets or drainage layers in a cartridge volume (the space between the core and the cage in a cylindrical filter cartridge), has a value above a given threshold value. In this case, for example, leg portions of adjacent pleats (the length along the filter membrane from the core side to the cage side) may begin to touch one another, when they become above a certain density of membrane pleating relative to a fixed volume filter cartridge volume available for the membrane in the filter cartridge and the flow rate begins to decrease. A further increase in the membrane area or the pleat density (the number of pleats per arc length unit or linear length unit) relative to the volume of cartridge, which has no pleated non woven net bonded to the upstream side of the membrane and has the woven net disposed on the downstream side of the membrane, would result in a decrease in the fluid flow through the filter.

A variety of pleats can be used to make filter cartridges according to the present invention. For example, and without limitations the pleats can be “W” type pleats (there are low mountain folds not reaching to the inner surface of the cage between high mountain folds, the number of pleats at the core side is greater than that at the cage side), “M” type pleats (there are balley folds not reaching to the outer surface of the core between high mountain folds, the number of pleats at the cage side is greater than that at the core side), or a combination of them. In other embodiment, the pleats can be close contact type in which adjacent pleats contact closely each other (see U.S. Pat. No. 5,543,047),

The membrane area can be determined by the number of pleats and their geometric area. Alternatively, the membrane area can be determined relative to pleated nets and membranes having a similar configuration as a control reference. That is to say, in this method, the flow rate of the filter cartridge having a membrane with known membrane area is compared with that of a filter cartridge to be tested under a constant feed pressure, and the membrane area is determined based on a predetermined calibration curve.

Table 1 illustrates some examples of the present invention, for example, example M3, which has a combination body of the pleated non-woven net or drainage layer disposed on the upstream or retentate side of the pleated microporous membrane, and the pleated woven net or drainage layer disposed on the downstream or permeate side of the pleated microporous membrane. Table 1 illustrates other filter cartridges, for example, example M1, which have the same pleating configuration as M3 but a different membrane area for the same cartridge volume, and has two woven drainage layers disposed on both sides of the membrane.

Table 1 and FIG. 1 illustrate, for example as X1 and X4, that, for the fixed volume of the cartridge, X4 has further increased the membrane from X1 to X4 by using the non-woven net disposed on the upstream side of the membrane and the woven net disposed on the downstream side of the membrane and thus, results in an increase in the fluid flow through the filter cartridge under a set of fixed feed conditions of flow and pressure. When the woven nets or drainage layers ware used on the upstream and downstream sides, an increase is the membrane area for X1 from 13,121 cm² to 16,632 cm² would not result in not so large increased flow rate compared to the embodiment of the present invention using the non-woven net or drainage layer on the upstream side. In addition, a valve point pressure is inversely proportional to a pore diameter of the membrane and proportional to surface tension and contact angle between the fluid and the membrane. Thus, the inverse of the valve point pressure is proportional to the pore diameter of the membrane, if the materials of the fluid and the membrane are the same.

Table 1 and FIG. 1 illustrate, for example as M1 and M2 or M3, that, for the fixed volume of the cartridge, the use of the nonwoven net on the upstream side of the membrane and the woven net on the downstream side of the membrane for further increasing in membrane area from M1 to M2 or M3 results in an increase in the fluid flow through the filter cartridge under a set of fixed feed conditions of flow and pressure. When the woven nets or layers were used on the upstream and downstream sides of the membrane, an increase in the membrane area for M1 from 18,272 cm² to 23,285 cm² would not result in not so large increased flow rate compared to the example of the present invention.

Table 1 and FIG. 1 also illustrate the condition where the membrane area to the filter cartridge in an embodiment of the present invention, for example M3, divided by the membrane area to a second reference filter cartridge (a conventional filter cartridge), for example M1, is smaller than the value of the flow rate of the pre-wet M3 divided by the flow rate of the pre-wet M1. This is advantageous because a small increase in the surface area can result in a large increase in the flow rate.

In an embodiment of the present invention, as illustrated in FIG. 3 with its section, the filter cartridge or filter element can consist of a core 3, an inner (or downstream) side net (or drainage layer) 5 disposed on the core facing surfaces of the porous membrane 7, the porous membrane 7, an outer (or upstream) side net (or drainage layer) 9 disposed on cage facing surfaces of the porous membrane 7, and said cage 11 positioned about said drainage layer and porous membrane. The filter cartridge can also include end caps (not shown in FIG. 3) sealing top and bottom sides, at least one of which is provided with apertures for fluid flow. The ends of these members (the membranes and drainage layers) of the filter cartridge may be bonded to any one or both of the end caps of the filter cartridge so as to make an integrated filter cartridge, by means of any suitable means providing sufficient integrity and intensity to the filter cartridge, for example melt bonding or potting. Any one or both of the end caps can comprise fittings that can be used to mount (for example but not limited to o-rings or screw) or bond the cartridge to a manifold. In some embodiments, the filter cartridge may be bonded to the manifold along with a housing, or any one or both of the caps can have fittings that allow them to be replaceably sealed or removed from the manifold along with an external housing that can be attached to the manifold.

The membrane media with the nonwoven upstream layer and the woven downstream layer can be used to remove particles, ions, or any combination of these from a fluid or slurry. In some embodiments, the membrane is a depth media, and in other embodiments, the membrane is a microporous media. The media may be formed of any material used in the pleated filter cartridge. These materials can include paper, other cellulose material such as regenerated cellulose or nitrocellulose; thermoplastic made of homopolymer, copolymer or terpolymer such as polyolefin including polyethylene (for example ultrahigh molecular weight polyethylene) and polypropylene; PVDF, PTFE resin, PFA, ECTFE and other fluorinated resin, particularly perfluorinated thermoplastic resin; PVC, nylon, polyamide, polysulphone, modified polysulphone (such as polyethersulphone, polyarylsulphone and polyphenylsulphone), polyimide, polycarbonate, PET, combinations of these, and the like.

The microporous membrane pores can have a sieving retention of 3LRV or more for particles. The particle size can be below about 1 micron, in some embodiments, below about 0.05 micron, and, in other embodiments, below about 0.03 micron. The membrane can include ion removal functional groups, adsorbent material or exchange materials (ion exchange resin, carbon, and the like) on its surface.

The woven net can be made of preferably thermoplastic material made of homopolymer, copolymer or terpolymer such as polyolefin including polyethylene, for example ultrahigh molecular weight polyethylene and polypropylene; PVDF, PTFE resin, PFA, ECTFE and other fluorinated resin, particularly perfluorinated thermoplastic resin, PVC, nylon, polyamide, polysulphone, modified polysulphone (such as polyethersulphone, polyarylsulphone and polyphenylsulphone), polyimide, polycarbonate, PET, combinations of these, and the like. An example of such net is Gunze Net (trade name, available from Gunze Corp.). The location of the woven net (net can also be referred to as a membrane support, drainage layer, mesh, screen) can be on the downstream side (also referred to as an inner side, or filtrate side, or permeate side) of the membrane. In some embodiments, the non-woven net is thicker than the woven net.

The non-woven net or apertured film can be made of plastics, preferably thermoplastic material. These can include but are not limited to materials such as thermoplastic material made of homopolymer, copolymer or terpolymer such as polyolefin including polyethylene (for example ultrahigh molecular weight polyethylene) and polypropylene; PVDF, PTFE resin, PFA, ECTFE and other fluorinated resin, particularly perfluorinated thermoplastic resin, PFA, ECTFE and other polyamide, polysulphone, modified polysulphone (such as polyethersulphone, polyarylsulphone and polyphenylsulphone), polyimide, polycarbonate, PET, combinations of these, and the like. Examples of this apertured film include but are not limited to Dexmet 2TF9-H100 0.27 t (270 μm in thickness) and Dexmet 5TF8-105 0.39 t (390 μm in thickness) (available from Dexmet Corp. Connecticut, USA), or others. The location of the non-woven net (also referred to as a membrane support, drainage layer, mesh, screen) can be upstream or retentate side of the membrane.

In some embodiments of the present invention, the non-woven net drainage layer can be pleated with the membrane using the same pleater as the woven drainage layer. When the non-woven net drainage layer is used in the same pleater as the woven net, the non-woven net drainage layer can have a dissipation property of a static charge similar to that of the woven net. In other embodiments of the present invention, the thickness of the non-woven or the apertured net may be thicker than woven net.

The downstream net or drainage layer can be located near the core of the filter device, and the upstream net or drainage layer can be located near the cage of the filter device. In an embodiment of the present invention, when the non-woven drainage layer is located at upstream side of the pleated membranes the filter medium can be prevented from coming into contact with one another and the fluid can evenly flow to or from substantially all portions of the surface of the pleated filter membrane. Thus, a large surface area of the filter medium may be effectively used for filtration.

The core, cage and end caps of the filter cartridge may be made of a plastic. In some embodiments, thermoplastic resins can be used for them. These can include but not limited to polyolefins such as polyethylene, ultrahigh molecular weight polyethylene, polypropylene, polyolefin made of copolymer or terpolymer, nylon, PTFE resin, PFA, PVDF, ECTFE and other fluorinated resin, particularly perfluorinated thermoplastic resin, polycarbonate, polysulphone, modified polysulphone (such as polyethersulphone, polyarylsulphones and polyphenylsulphones), or blends thereof.

FIG. 1 is a graph illustrating the flow rate of water for various configurations of woven net materials and non-woven net materials. The tests were performed on ATX and ATM filter cartridge (trade name) available from Entegris, Inc (USA) that were modified to include a larger number of pleats and different types and arrangements of the woven and non-woven nets.

X1-X3 show ATX cartridge (Type A) having pleating arrangement, which had smaller total membrane area than X4 (Type B) as shown with FIG. 2. On the other hand, X4 (Type B) has a higher density of pleats arrangement than X1-X3 as shown with FIG. 2, and has a larger total membrane area of about 27% greater than that of X1 and also an increase in flow rate of about 18% greater than that of X1.

In Table 1, M1 is an ATM cartridge with about 40% larger membrane area (18,275 cm²) than the X1 cartridge. The pleat structure of M1 is different from that of X1.

The flow test results for X1-X4 show that net type and position (upstream or downstream side) can affect the flow rate. The results for X3 and X4 show that, when the nonwoven or apertured film is disposed on the upstream side of the pleated membrane, increased filter area permits increased flow for a fixed cartridge volume.

The flow test results for M1-M3 show that, when the nonwoven net or apertured film is disposed on the upstream side of the pleated membrane, increased filter area permits increased flow rate for the fixed filter cartridge volume. The result of M2 shows that, when the non-woven net is disposed on the upstream side of the pleats, a 27% increase in the filter area provides about a 20% increase in the flow rate. The result of M3 shows that, when the non-woven net is disposed on the upstream side of the pleated membrane, a 20% increase in the filter area provides about 32-40% increase in the flow rate. These results show that, when the non-woven net is disposed on the upstream side of the pleated filter membrane and the woven net is disposed on the downstream side thereof, a large flow rate of fluid flow through the device can be provided by combining with the pleating configuration or membrane area.

These results show that, when the non-woven net is disposed on the upstream side of the filter membrane and the woven net is disposed on the downstream side thereof, a larger fluid flow through the filtration device than that through the same filtration device with the woven net disposed on the upstream and downstream sides of the filter membrane can be provided by combining with the pleating configuration and/or membrane area. It would not have been predictable that such increase in the flow rate is obtained by the combination of the location of the net material and the pleat.

These results show that, when the non-woven net is located at the upstream or retentate side of the filter membrane and the woven net is located at downstream or permeate side thereof, higher fluid flow through the filtration device than that through the same filtration device with the woven net located at the upstream and downstream sides of the filter membrane can be provided by combining with the pleating configuration (size, density, type (M type, W type, a combination thereof). It would not have been predictable that such non-linear increase in flow rate is obtained by the combination of the location of the net material, the type of the net material, and the pleat density.

Table 1 shows the filter area) bubble point and flow rate for filters obtained by pleating woven, and non-woven supports having different configurations.

Gunze (trade name) is a woven net with a thickness of 200 μm and Dexmet 2TF-H100 (trade name) is a non-woven net with a thickness of 270 μm.

The increase ratio in the area of the porous membranes is a percentage increase relative to the average of X1 and X2 for X series, and a percentage increase relative to the average of M1 for M series.

The manual babble point is the pressure difference between the upstream flow plane and the downstream flow plane of the porous membrane at the time of observation of the babble occurring.

TABLE 1

| | | | | | | Pre-Wet Flow rate | |
|---|---|---|---|---|---|---|---|
| | | | | | Manual | water liter/mm (at 0.2 | |
| | Filter Area | | Support Net | | Babble | kg/cm²) | |
| | | Increase | Upstream | Downstream | Point, BP | (liter/ | Increase |
| Sample | cm² | Ratio (%) | (outer) | (inner) | Psi | min) | Ratio (%) |
| Type X | | | | | | | |
| X1 | 13,121 | 0 | Gunze | Gunze | >50 | 10.4 | 0 |
| | | | (woven) | (woven) | | | |
| X2 | 13,121 | 0 | Gunze | Gunze | >50 | 10.9 | 0 |
| | | | (woven) | (woven) | | | |
| X3 | 16,632 | 27 | Dexmet | Gunze | >50 | 12.6 | 18.3 |
| | | | 2TF9-H100 | (woven) | | | |
| | | | (non-woven) | | | | |
| Type M | | | | | | | |
| M1 | 18,278 | 0 | Gunze | Gunze | >30 | 14.8 | 0 |
| | | | (woven) | (woven) | | | |
| M2 | 23,285 | 27 | Dexmet | Gunze | >30 | 17.8 | 20.3 |
| | | | 2TF9-H100 | (woven) | | | |
| | | | (non-woven) | | | | |
| M3 | 21,991 | 20 | Dexmet | Gunze | >30 | 20.7 | 39.9 |
| | | | 2TF9-H100 | (woven) | | | |
| | | | (non-woven) | | | | |
| M3a | 21,991 | 20 | Dexmet | Gunze | >30 | 19.7 | 33.1 |
| (repeat 1) | | | 2TF9-H100 | (woven) | | | |
| | | | (non-woven | | | | |
| M3b | 21,991 | 20 | Dexmet | Gunze | >30 | 19.7 | 33.1 |
| (repeat 2) | | | 2TF9-H100 | (woven) | | | |
| | | | (non-woven | | | | |
| M3c | 21,991 | 20 | Dexmet | Gunze | >30 | 19.6 | 32.4 |
| (repeat 3) | | | 2TF9-H100 | (woven) | | | |
| | | | (non-woven | | | | |

The results are shown with table 1. The increase ratio in the flow rate (%) is a percentage increase relative to the average of X1 and X2 for X series, and a percentage increase relative to the average of M1 for M series. It is understood that the flow rate processed by the invention can be larger than that processed by a reference filter cartridge.

Although the present invention has been described in considerable detail with reference to certain preferred embodiments thereof, other versions are possible. Therefore the spirit of the present invention and scope of the appended claims should not be limited to the description and the preferred embodiments contained within this specification.

### BRIEF DESCRIPTION OF THE DRAWINGS

FIG. 1 is a graph illustrating the flow rate for the types of the nets and the area of the porous membrane in the filter cartridge, in which various woven and non-woven net are located at both planes of the pleated microporous membrane.

FIG. 2 illustrates that pleating of a combination of the woven net on the outside (upstream side) of the microporous membrane facing the cage, and the woven net on the inside (downstream side) of the membrane facing the core can increase filter membrane area that can be utilized in a volume of a filter cartridge (space between the cage and core), and that, for woven net disposed on the upstream and downstream pleated membrane surfaces, an increase in membrane area so as to give the filter cartridge of Type B to filter cartridge of Type A having a fixed volume could lead to reduced fluid flow under fixed feed conditions.

FIG. 3 illustrates that the filter cartridge used in embodiments of the invention has a core, pleated inner net, pleated membrane, and pleated outer net within a support cage.

FIG. 4 is a cross-sectional illustration of the pleated microporous membrane bonded to inner and upstream net contained in the volume between the core and cage of the filter cartridge (top and bottom end caps not shown).

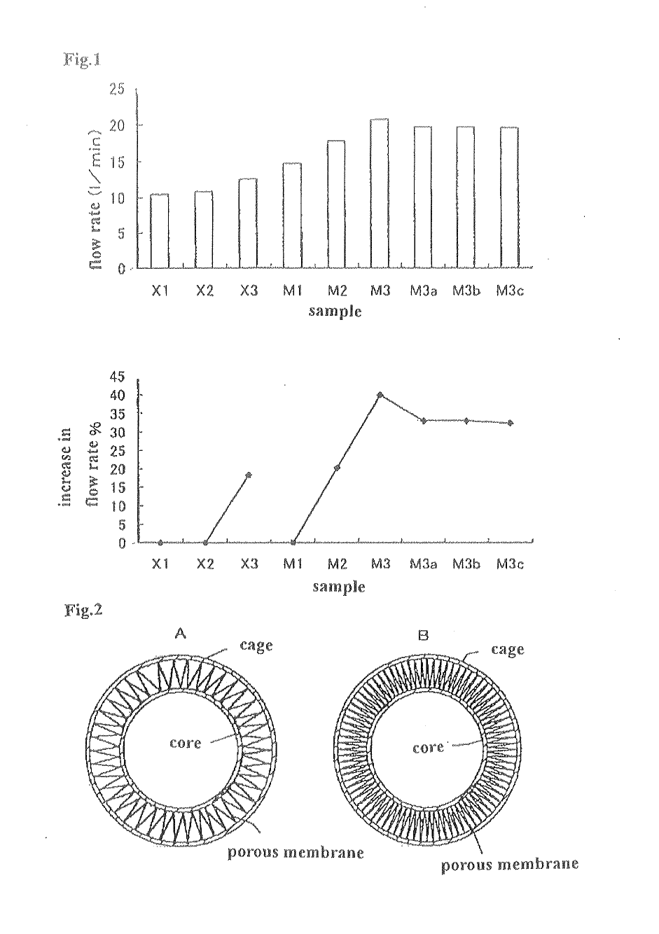

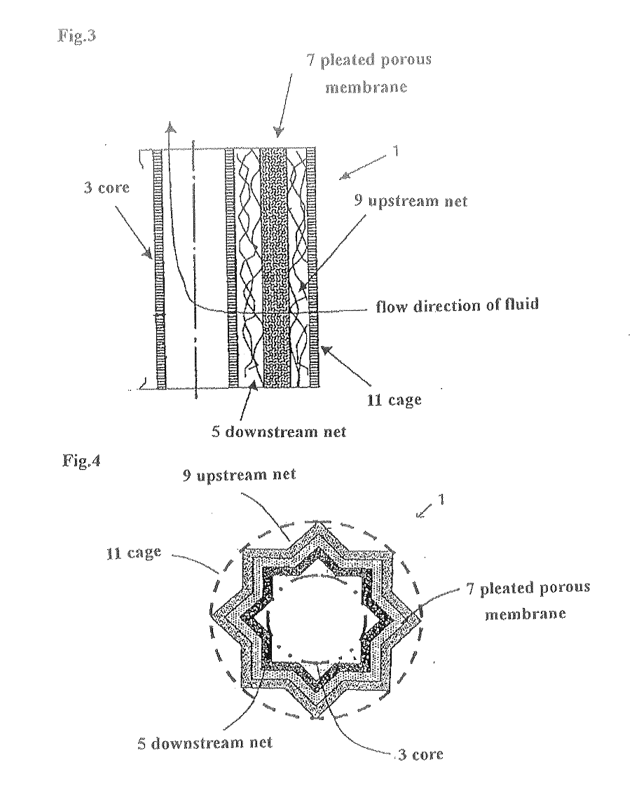

### DESCRIPTION OF REFERENCE NUMERAL

3 core
5 downstream net
7 porous membrane
9 upstream net
11 cage

1. A filter cartridge containing a filter material, which comprises a pleated porous membrane, a pleated non-woven net disposed on the upstream side of said membrane, and a pleated woven net pleated nonwoven net disposed on the downstream side of said membrane, these joined together at edge portions thereof, wherein said filter cartridge has an increased flow rate relative to the flow rate of a reference filter cartridge containing a filter material, which comprises a pleated porous membranes a pleated woven net disposed on the upstream side of said membrane, and a pleated woven net disposed on the downstream side of said membrane, these joined together at edge portions thereof.

2. The filter cartridge according to claim 1, wherein said filter cartridge has a first membrane area and said reference filter cartridge has a second membrane area, and a ratio of first membrane area to second membrane area is less than a ratio of the flow rate of said filter cartridge to the flow rate of said reference filter cartridge.

3. The filter cartridge according to claim 1, wherein said non-woven net is pleated with said membrane using the same pleater as the woven net.

4. The filter cartridge according to claim 1, wherein said reference filter cartridge containing the filter material, which comprises the pleated porous membrane, the pleated woven net disposed on the upstream side of said membrane, and the pleated woven net disposed on the downstream side of said membrane, these joined together at edge portions thereof, has a volume such that an increase in said membrane area under the condition of its fixed volume results in a decrease in the flow rate through the filter cartridge under a fixed feed condition of flow and pressure.

5. The filter cartridge according to claim 1, wherein said reference filter cartridge containing the filter material, which comprises the pleated porous membrane, the pleated woven net disposed on the upstream side of said membrane, and the pleated woven net disposed on the downstream side of said membrane, these joined together at edge portions thereof, has a volume such that an increase in pleat density of said membrane under the condition of its fixed volume results in a decrease in the flow rate through the filter cartridge under a fixed feed condition of flow and pressure.

6. The filter cartridge according to claim 1, wherein said porous membrane is a flat sheet microporous membrane.
